(19) United States
(12) Patent Application Publication
(10) Pub. No.: US 2007/0175401 A1
(43) Pub. Date: Aug. 2, 2007

(54) Economic easy clean cat toilet

(76) Inventor: Hai Tee Young, El Monte, CA (US)

Correspondence Address: HAI TEE YOUNG, P.O. Box 6301, Rosemead, CA, 91770, US

(21) Appl. No.: 11/222,492

(22) Filed: Sep. 8, 2005

(51) Int. Cl. A01K 29/00

(52) U.S. Cl. 119/166

(57) ABSTRACT

Two tub containers are piled together, inside upper top one storing litter of either very tiny stones or other tiny solid material, where cats can bury feces; in bottom of upper tub container making tiny seams and slits to let cats' urine pass downward to hygiene water in lower tub container, or to earth and lawn. Scoops are for use to remove dung away. As urine is not absorbed by the litter, but pass to elsewhere and dung can be picked away, this cat toilet can always be kept clean without necessity constantly to replace litter, this will be much more economic and easier to keep clean as well as to protect environment.

### BACKGROUND OF THE PRESENT INVENTION

Cats are lovely animal and pet to most people, nevertheless, not all people who love cats like to have them in their own houses. The reason for that is not for people can not afford to feed them, but tiresomeness to clean their feces. Not only the equipment to clean their feces is more expensive than the food to feed them, also the bad odor it creates will make people mad. As in an era people's attention to concern environment protection, accumulation of those feces and litter will pollute our environment

### SUMMARY OF THE RELATED DESIGN

So we design the devices to reduce and make this problem as minimum as possible: A. to make cats' urine freely flow out without being retained in the litter tub container where their urine and dung firstly pass on. Urine problem is even more tiresome than dung, because when urine flows to container, it spread all over in container tub and then absorbed into litter. Later, it automatically evaporates into air to bother people. If not evaporate, absorbed into litter, litter will become stink and has to be changed. While cats' dung evaporate its bad odor only in initial several minutes, after the odor of the surface evaporate out, the surface of dung itself become a membrane or enveloping coating to block internal odor to evaporate out, it bother no longer to people, or minimize itself to the degree people don't feel it if people don't go approach it. And then can wait and pick them out by scoop or any other instruments in maximum time people can wait.

In order to separate urine and dung, let urine pass through automatically to elsewhere without retaining in litter to be mixed with dung, we design two tub containers to be piled together, the upper one must have a number of open seams in bottom through where cats' urine can pass downward to lower container which holds either detergent water or plain water in order to dilute urine. In this manner, dung and urine can be separately picked away and exchanged with new clean water. The litters are polluted in minimum and can be continued to use, prolong the time of use and multiple the length of time to tens even hundreds times,

### DESCRIPTION OF THE DRAWINGS & THE EMBODIMENTS

The present invention we design are composed and described in following drawings & embodiments:

FIG. 1 shows the way how these two basic parts of upper tub container BC with many tiny opening seams in bottom and brackets on both sides; and lower tub container D to be piled together;

FIG. 2 shows the way how these two basic parts of upper and lower tub containers separate from each other; how the upper container BC looks like in an independent position.

FIG. 3 shows the way how the lower container D looks like in an independent position.

FIG. 4 shows upper tub container BC has four feet Bcf under four corners of its bottom. From FIG. 1 to FIG. 3 designed for the cats inside house, but this one is designed for cats' outside house, or house cats go and play outside. Though cats have the habit usually to bury their feces in ground, but still many cats don't bury them and exposing nudely if where they do their toilet were hard ground of either hard soil or even stone and cement, they can not bury their feces. Thus, in people's yards and gardens, cats' feces may be exposed and stink everywhere. But if we place this toilet in our yard and garden, both our own cats and guest cats can do their toilet here without polluting air and atmosphere. The reason we install four feet under the bottom is because if this apparatus placed on yard and lawn under where is earth and soil, then, the earth and soil will absorb the urine. In order to let urine evaporate as easy and fast as possible, it has to elevate the tub container, not let tub container directly rest on ground all the time, thus, the downing urine will constantly concentrate on one spot, a space over condensed by urine, if the speed transferring urine into earth and fertilizer is slower than the speed of urine's downing, the urine will still stink the atmosphere. Therefore, we install four feet under the bottom, the downing urine will not confined only in one spot, but spread over as wider as possible. Thus, the bad odor will be evaporated and urine transferred into earth and fertilizer faster.

FIG. 5, make upper top tub container be installed with four feet, instead of to place those toilets inside house, people can also place these toilets on lawns and gardens. Without those toilets on lawn and yard, cats will do toilets anywhere, it is easier to clean cats' feces through those toilets than to clan cats toilets on ground everywhere. We purposely demonstrate upper tub container BC and BC with four feet here for comparison.

FIG. 5 shows the foot in enlarged vision, it can plainly be put under upper container or be inserted with upper container

FIG. 6 shows the scoops, big one AAa which is going to place in the space BCb of bracket BCa; small one AAb which is going to place in space of BCc, also the extension handler Aab, going to place in space BCd of bracket BCe, to be accommodated with the upper tub container BC (Please refer to refer to both figures FIG. 1 and FIG. 4 lower lower figure). In order to hold scoop strong, male outstanding screwing slat Aac of extended handler Aab shall screw into female troughs of scoop's both handler AAa, AAb.

Now we have further describe pivotal points of present invention:

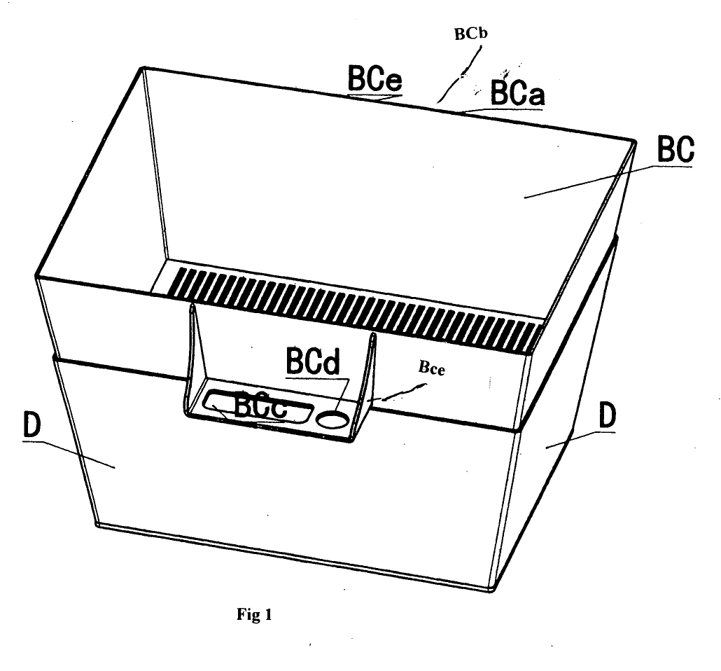

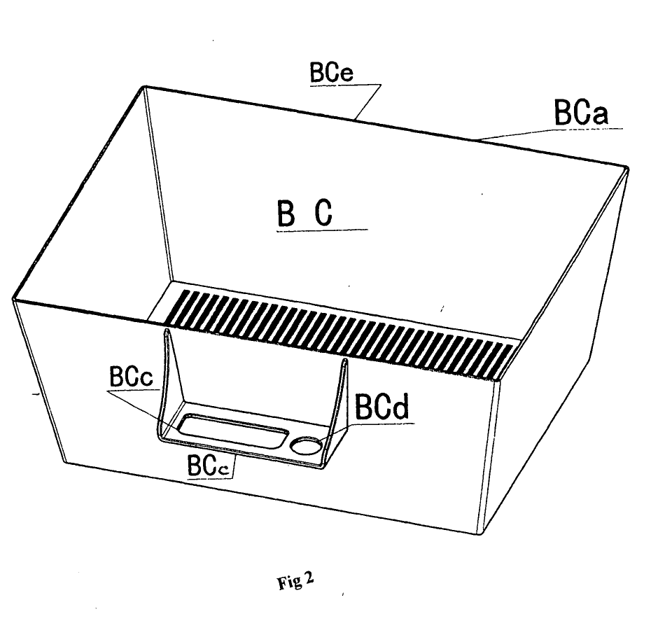

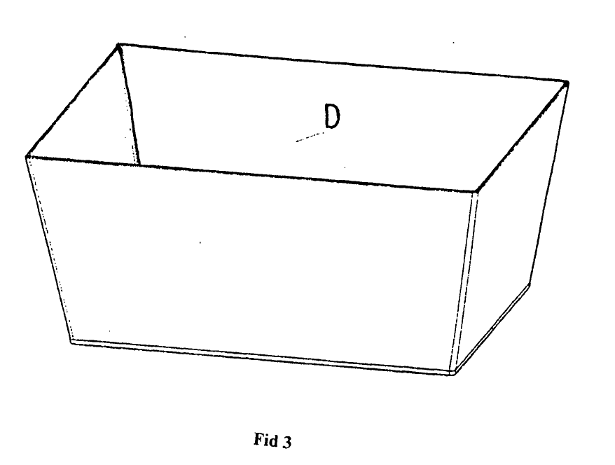

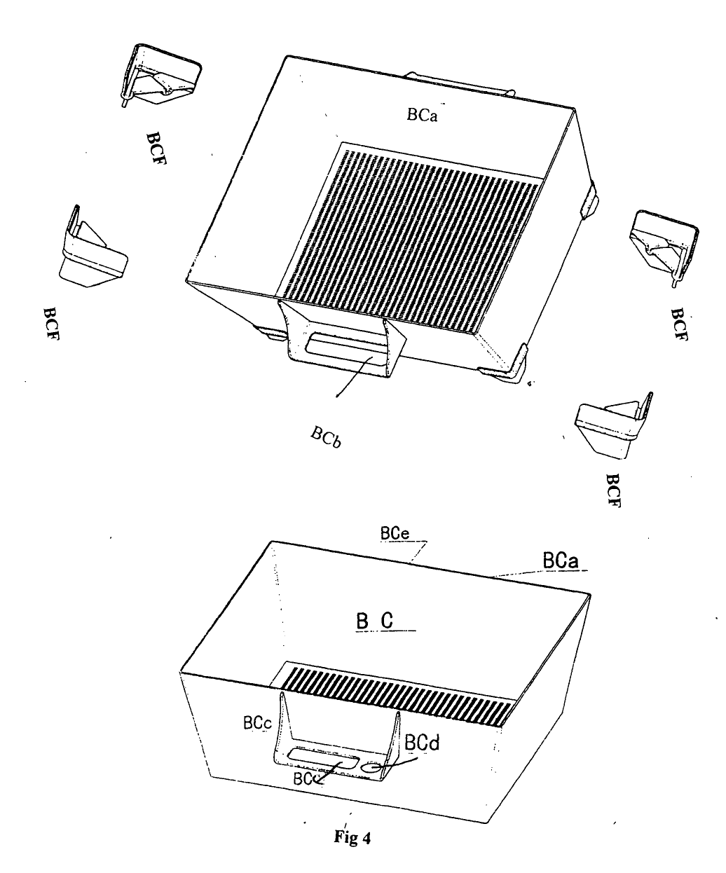

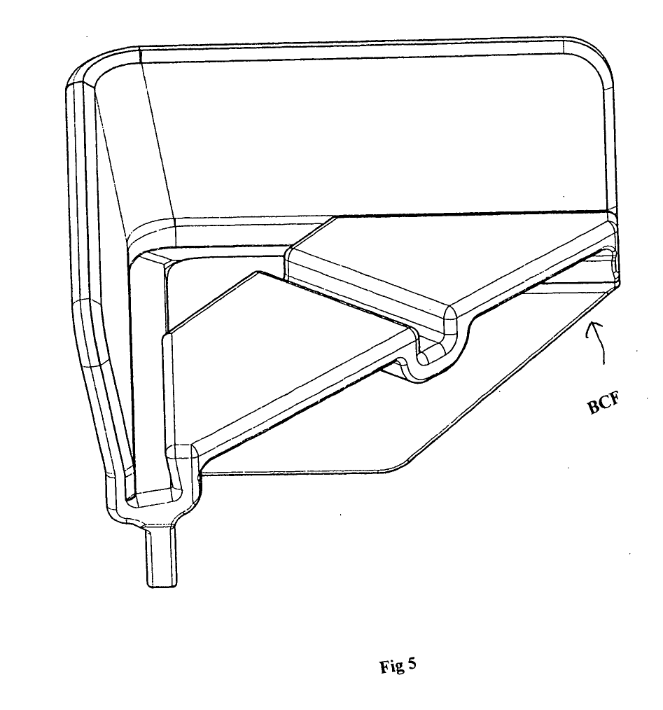

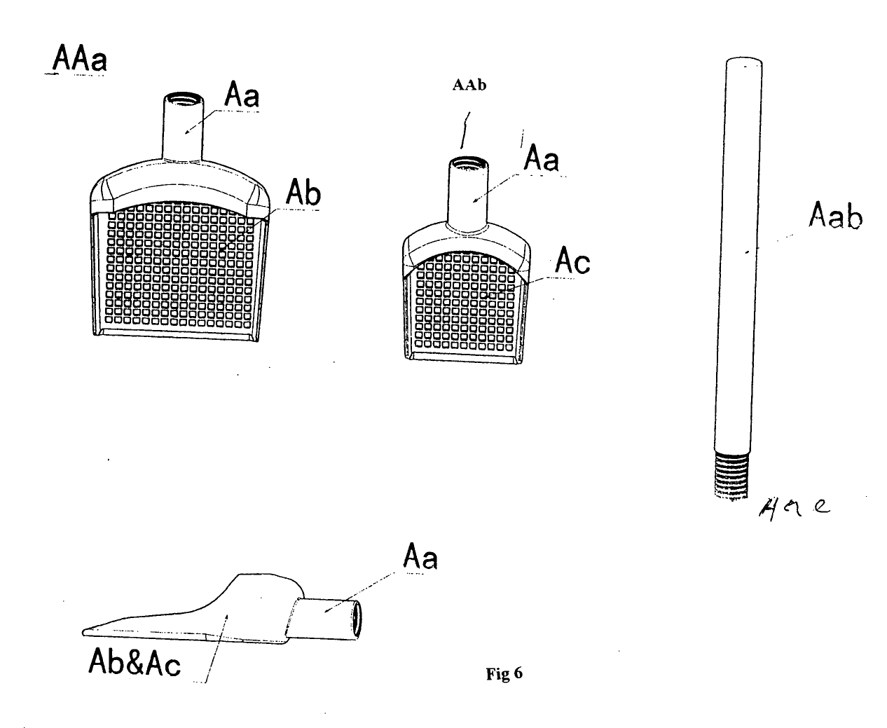

Though in FIG. 1 & FIG. 2, the upper top tub container BC is in quadrangular or rectangular shape, actually it can be in round, triangle and any different kinds of shapes.

The open top of BC must be longer and little wider than the bottom one, it's bottom where were made tiny seams and slits through where cats' urine can pass downward to water of lower tub container D.

The two brackets at two sides of BC can be used for both purposes to lift up BC in order to let lower tub container D change inside water and its space within brackets as BCa BCc BCd place big and small scoops and their extension handle.

The lower tub container D shall be same shape as upper top tub container BC, but its size of open top must be smaller than the middle line of upper container, hold upper container at middle, make hoarding space for detergent water to receive downing urine of cats.

Here we design small and big scoops. When people have a single and small cat, and clean it frequently, it needs to use the small scoop only; when people have a number of cats, or big cat, and clean it after a number of days, it needs big scoop, the extension handle Aab is used to join scoop and extension stick, thus make the taller person easier to clean it, also distant the remained bad order farther.

1. two tubs sit upper and down together, upper one has litters litter inside to let cat(s) bury their feces,
lower tub has the hygiene or bleach or ordinary water inside to receive cat(s)' urine from upper tub's seams.

2. from claim 1, seams in upper tub's bottom to let cat(s)' urine pass through downward to lower tub's hygiene, bleach or ordinary water, upper tub does not keep cat's urine; not let cat(s)' paws soaked in their own urine without odor of stink; the seams can let liquid pass downward, but not let litters fall down meantime

3. there are seams under scoop is big enough to let litters fall downward in upper tub without cat(s)' feces; cat's feces can not pass through scoop's seams,

4. there is an extension stick to screw into screws' handlers, human can pick out cat(s') feces without approaching the tiredness of cat(s)' stink feces. There are two scoops: small one for small single cat, big one for big multiple cats; or for single small cat doing toilet many days;

5. there are two brackets on two sides of upper tub for people's easiness to lift the upper tub to dump inside liquid; also for to insert the two scoops and extension stick,

6. hygiene water or bleach in the water in lower tub,

7. though we make rectangle shape for example, actually it can be round, square and any other shapes.

8. there are four feet under upper tub alone, people can make it lay on lawn and outside house, guest cats and wild cats can also do toilet there, without such a toilet, all cats will do toilet without possibility to bury their feces.

9. upper tub BC can be removable, otherwise, urine will be concentrated on one spot; over density of urine will also make a spot stink and tired, so the tub has to be removable to other spots, cat's urine will not be concentrated in one spot.
